(19) United States
(12) Patent Application Publication
(10) Pub. No.: US 2003/0065623 A1
(43) Pub. Date: Apr. 3, 2003

(54) Service, method and apparatus for receipt, authentication, transformation and delivery of transactions using a computer network

(76) Inventors: Chad Corneil, Boca Raton, FL (US); Dean McCall, Lake Worth, FL (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/968,224

(22) Filed: Oct. 1, 2001

(51) Int. Cl. G06F 17/60

(52) U.S. Cl. 705/64

(57) ABSTRACT

A service, method, apparatus and/or network configuration that provides the exchange of electronic data or message transactions through a third party network service between trading partners that have disparate systems is provided herein. Value added services are performed to the data including, but not limited to authentication, validation, transformation and routing of a plurality of trading partners' electronic transactions. The trading partners can access the centralized computing platform through a plurality of connection protocols, including, but not limited to FTP, HTTP, JMS and SMTP, to deliver data for processing. The trading partner data can be represented in multiple format types including, but not limited to EDI, XML, TXT and CSV that is typically in a different format than the trading partner that the transactions are delivered to. The system uses a centralized computing platform to receive input messages from one or more trading partners in one or more message formats. If required messages are transformed to a second message format and second data representation corresponding to a second trading partner. The data is then sent to the plurality of trading partners as required by the originating trading partner. The service, method, apparatus and/or network configuration reduces a cost associated with integrating a pair of trading partners to facilitate communication between them. The services, apparatus and method performed thereby are operated by a central, independent entity. The present invention obviates the need, common to prior techniques, for individual corporations to construct and manage a large number of input and output formats as well as manage multiple security configurations, message transport protocols, message validation, authentication and routing technologies.

### BACKGROUND

A trend has been observed that business enterprises increasingly use electronic networks, such as the global computer network known as the Internet, for communicating internally and for communicating with their trading partners. Management and integration of information between business partners continues to be a significant challenge across multiple businesses and industries. Despite advancements in technology and the emergence of standards for electronic interchange of business documents, companies are faced with difficult decisions on how they can integrate their system internally and externally to gain cost and competitive advantages.

Electronic document exchange could theoretically allow organizations to quickly and cost effectively exchange data with their trading partners. In practice, the speed and cost advantages of theory are not fully realized. Business documents encompass a large set of transactions that can be automated and include, but are not limited to purchase orders, sales orders or inventory items. Business documents can also include other data, content or system usage information that needs to be transacted between business partners. Examples of information exchange methods include manual processes, electronic data interchange (EDI) software solutions, in-house customizations to packaged or legacy software solutions and web based on-line ordering solutions.

One problem with methods of exchanging electronic business documents is that there are a number of point-to-point integration issues that must be addressed with every business partner with whom a customer desires to transact business electronically. Point-to-point custom integration projects with trading partners require the coordination of technology, security standards and data formats between each pair of business partners. If companies want to engage with more than one business partner, the costs escalate exponentially. Individual custom integrations with each trading partner require several repetitive non-scalable solutions that have to be reworked each time there are changes to either end of the system.

Electronic Data Interchange (EDI) can also be used to exchange business documents with trading partners. EDI may even appear at first to avoid point-to-point integration issues. However, companies are required to adhere to inflexible data formats and apparatuses and pay high proprietary network and interconnect costs. This results in a difficult, inflexible and expensive point-to-point integration with trading partners. Because EDI is expensive, it is typically used and managed by large corporations. Therefore, EDI solutions may be out of the reach for smaller organizations and they do not scale easily to a large number of trading partners.

EDI systems have been used in the past for communication between trading partners. The conventional EDI model requires the implementation of a translation and communication software system within each enterprise to be integrated. These are usually provided as stand-alone products to each of the trading partners. The separate translation systems and communication systems are then connected together through a network. The result is costly and difficult to implement because the EDI software of each enterprise must be configured to communicate with the EDI software of each other enterprise. The software installed at each enterprise requires annual maintenance fees and ongoing operational costs to ensure that the systems continue to operate. As the number of trading partners increases, the cost increases exponentially. Although EDI software systems typically use a hub-and-spoke topology, the conventional wisdom holds the topology not to be extensible to solve the problem of routing information between trading partners. This is because the number of trading partners likely to be involved in any one scenario, as well as the lack of common data formats, applications, security methods, communication protocols, etc. among a plurality of trading partners. If no EDI facility is used, there may be a large number of document formats to be dealt with. Each pair of business partners desiring to interact will need to set up the apparatus, document formats and content standards needed for their particular circumstance. When a new partner or software package is introduced into the mix, the apparatus, formats and content standards of all the affected partners must be updated.

There are significant repetitive non-scalable costs associated with point-to-point connection of multiple trading partners, whether using EDI or newer Enterprise Application Integration (EAI) or Business to Business Integration (B2Bi) technologies. The problem is not with the apparatus itself, but the fact that none of the conventional technologies readily scale beyond a single corporation and a small percentage of the trading partner network.

Where the number of trading partners is large, as is common among trading partner networks, the number of such procedures to secure, transmit, format and re-format and deliver electronic documents is exponentially large. For example if there were 20 trading partners within a distributed partner network, the number of procedures to secure, transmit, format and re-format and deliver electronic documents is:

$$\frac{20 \cdot 19}{2}$$

The number of procedures required to completely define all security, transmission protocols, data formats and delivery protocols for electronic documents are exponential in the number of trading partners supported. Specifically the number of procedures required for N format specifications is:

$$\frac{N \cdot ( N - 1 )}{2}$$

Though some procedures may be in common for some trading partner pairs, thus reducing the total number required, it is not uncommon for all procedures to be required to be different in such document exchange distributed computing environments.

### SUMMARY

A need exists for an improved method and apparatus for managing the receipt, authentication, validation, transformation and delivery of trading partners' electronic transactions and information. Embodiments of aspects of the present invention solve various problems of the prior art.

According to an embodiment of one aspect of the invention, a method of facilitating communication of electronic data between a plurality of trading partners through a managed third party network comprises: receiving an input message into the managed third party network, the input message conforming to an input schema from a first trading partner; storing the message; transforming the message into an intermediate format message conforming to a canonical schema; storing the transformed message; transforming the intermediate format message into an output message conforming to an output schema; and sending the output message over the network to a second trading partner adapted to receive messages conforming to the output schema. Variations on this method may further include tracking the events and services performed by the managed third party network, billing for the events tracked or connecting with one of the plurality of trading partners to bill for the events tracked. Yet other variations may include transforming the output message content into an intermediate content conforming to a canonical content format; storing the transformed message content; and transforming the intermediate content into the output message understood by the second trading partner, as well as optionally identifying the input message to at least one of the trading partners, billing for activities and events of the managed third party network, bills being directed to the one of the trading partners identified with the input message, identifying the output message to at least one of the trading partners, or billing for activities and events of the managed third party network, bills being directed to the one of the trading partners identified with the output message. According to some variations, the input schema and the output schema are different. The method may further include auditing messages to identify software usage information pertaining to a trading partner. Sending the output message to a second trading partner adapted to receive messages conforming to the output schema may further comprise sending the output message to an apparatus for internal application integration used by the second trading partner. There may also be means for providing secure authenticated and validated transactions, or means for facilitating communication between at least three trading partners at the same time connected to the network.

According to an embodiment of another aspect of the invention, a system through which a service managed by a third party facilitates communication between a plurality of trading partners, wherein a per-trading partner cost associated with receiving, authenticating, validating, translating and delivery of incoming messages and outgoing messages is reduced comprises: a first processor executing software to receive, queue and transmit an incoming message having message content in an incoming message format and an outgoing message in an outgoing message format; a first processor executing software to transform a message queued by the first processor into an intermediate message format conforming to a canonical schema, and to transform the message content into an outgoing message content representation according to a predetermined trading agreement; and software executing on the first processor to link processes executed on that first processor to a trading partner's system. Software executing on the first processor may transform a message in the intermediate message format into the outgoing message format. Software executing on the second processor may store information related to activities, events and processes performed within the system. The second processor may execute software to store XSLT libraries developed for mapping data as defined in the message headers and Trading Partner Profiles. The first processor may further comprise a communication handler that acts as a transport mechanism for multiple protocols to receive incoming messages from the plurality of trading partners. The software executing on the first processor may further comprise a message queuing engine which stores an incoming message on an incoming queue, and/or a message routing/scripting engine which retrieves from the incoming queue, a message for transformation. A database system may store and retrieve queued and transformed messages. A trading partner and system administrator user interface may be included, through which are obtained reports on queued and transformed messages. The user interface may be based on access to hypertext documents through a browser client. The user interface may be accessed through a world-wide computer network. The user interface may provide access to a System Administrator for system monitoring and support activities. A database system may store and retrieve the canonical schema. Messages may be represented in a markup language. The markup language may be an XML language. Alternatively, messages may be represented in a ANSI X.12 or Edifact language, or messages may be represented in a text or comma separated value language. The software to transform may include scripts written in XSLT. The system may process messages between the plurality of trading partners and compile billing information and records based on the messages processed. The system may receive messages for processing containing specific information about software usage by a trading partner from apparatuses located at the trading partner. An audit process may compile and analyze software usage information and message content information, whereby the third party subsequently charges a trading partner for services rendered. The message content may include audio files or video files.

### BRIEF DESCRIPTION OF THE DRAWINGS

In the drawings, in which like reference designations represent like elements:

FIG. 1 is a block diagram overview of a service, software system and network configuration-embodying aspects of the invention;

FIG. 2 is a more detailed block diagram of an embodiment of elements of FIG. 1;

FIG. 3 is a more detailed block diagram of a network configuration useful in connection with aspects of FIG. 1;

FIG. 4 is a flowchart of the processes to initiate a Trading Partner Profile in connection with FIG. 2;

FIG. 5 is a flowchart of the process to add and Maintain Trading Partner Profiles;

FIG. 6 is a flowchart of a method of processing messages embodying aspects of the invention;

FIG. 7 is a flowchart of a method of a billing process employing aspects of the invention; and

FIG. 8 is a flowchart of a method of tracking messages embodying aspects of the invention.

### DETAILED DESCRIPTION

The present invention will be better understood upon reading the following detailed description of various embodiments of aspects thereof in connection with the drawings.

Various problems of the prior art can be solved by a novel business method, i.e., service, software system and network configuration referred to herein variously as Application Integration or as an Application Integration Network. The Application Integration Network service, system and configuration permit applications of distinct, plural trading partners to communicate with each other by routing electronic documents through the managed network. Various value-added services are performed on the transactions defined in the electronic documents as they pass through the network. As a result, the documents can be reformatted and routed to an appropriate predetermined trading partner. However, the cost of implementing an Application Integration Network as a managed service according to the embodiments described hereinafter is lower than the cost that would be imposed by product-based solutions that are implemented at corporate locations or hosted at a managed service location for a single corporation.

The architecture of an illustrative Application Integration Network is broken down into physical and logical components and packages. Each component has a specific task or role to fulfill in the system. The major components are:

Network Foundation—a transaction processing system and storage mechanism for handling and routing electronic messages through the network.

Network Core—a service running on the Network Foundation that provides document transformation, mapping services, and standards management.

Communication Interface—provides a secure point of connectivity through standard communication interface between the Network Foundation and trading partners using the illustrative Application Integration Network.

Application Extensions (AppEx)—a set of tools made available to trading partners that assist with the process of applications communicating with the Gateway.

Applets—a collection of software tools and utilities that provides access to information and completes defined tasks or services in the Foundation.

Communication Handler—a set of tools made available to trading partners that assist with the process of routing of electronic messages and communication with the Network Foundation.

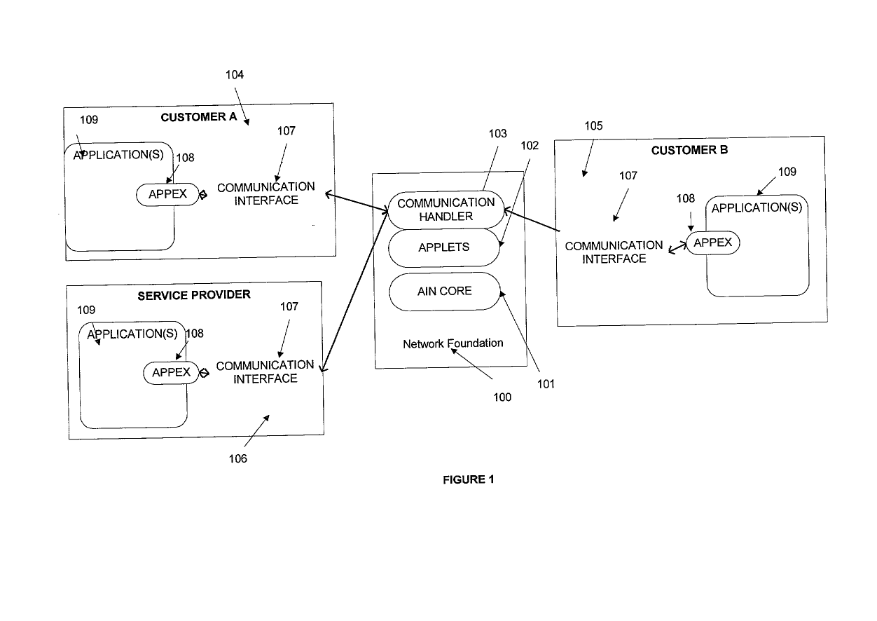

Security—a set of tools made available to trading partners that assist with the process of securing data to the network and include, but are not limited to validation, authentication and authorization. Each of these components is detailed below. Components are referred to herein generally as processes or software executing on a processor. Such processes may be functions, modules, methods, classes or other conventional programming structures, without loss of generality. Trading partners participating in the illustrative system are referred to as client trading partners because they are clients of the provider of the Application Integration Network services and trading partners of each other. The relationships between the components are illustrated in FIG. 1. The Network Core 101 running on the Network Foundation 100 is the hub of a communication system between plural client trading partners 104, 105 and 106. The bulk of the software code or Applets 102 are contained within the Network Foundation 100. The Communication handler 103 is also contained with in the Network Foundation 100. The client trading partners 104, 105 and 106 run Communication Interfaces 107 which communicate with the Network Foundation 100 on the one hand, and with applications 109 through Application Extensions 108 on the other hand. The Applications 109 and the Application Extensions or AppEx's 108 can be similar, however are more likely different at every trading partner.

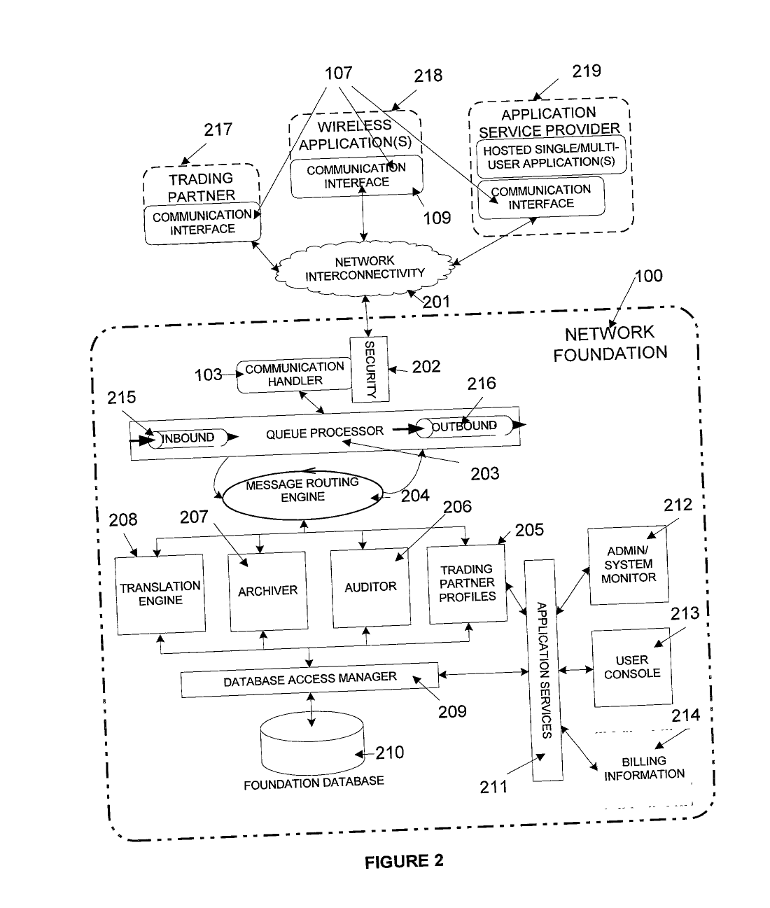

The Network Foundation 100, a transaction processing system for electronic messages, is now described in connection with FIG. 2. It will be understood from reading the entire description hereof that other messages including, but not limited to XML, EDI, text, CSV, video or audio could be similarly processed without departing from the spirit of the invention. The software architecture now described defines a component structure that is broken down by function. It will be understood that other partitions of the overall task to be achieved could also be used.

Messages reach the Application Integration Network through Network Interconnectivity 201. The communication network is not limited to the Network Interconnectivity 201 and can include virtual private networks (VPNs) and other private networks that the Application Integration Network is connected to. Messages pass through a layer of Security 202 which executes processes to assure the security of the messages received over the Network Interconnectivity 201, for example by validating authentication information. The Communication Handler 103 provides connectivity to the trading partners. The Communication Handler 103 understands and manages a number of communication protocols including, but not limited to HTTP, HTTPS, FTP, SMTP and JMS. The Queue Processor 203 maintains inbound and outbound electronic message queues, 215 and 216, respectively. The Queue Processor 203 buffers incoming messages in a simple FIFO queue 215 for processing by the Message Routing Engine 204, and sends messages in the outbound FIFO queue 216 to their destination Communication Interfaces 107, for example through the Network Interconnectivity 201. The inbound and outbound queues 215, 216 are preferably implemented, but not limited to using a Java Messenger Services (JMS) Queuing system and reside directly in the Foundation database 210. Other custom or readily available queuing technologies can be used including, but not limited to Bea Weblogic, Oracle Advanced Queueing, IBM MQ Series MS BizTalk Server or Progress Software Sonic MQ.

The Message Routing Engine 204 is the main execution thread for transaction processing in the Network Foundation 100. The Message Routing Engine 204 establishes and maintains the execution environment, provides global access to run-time session data, maintains running conversations, i.e. multi-message communication threads, and processes messages. The Message Routing Engine 204 retrieves incoming electronic messages in need of processing from the queue 215 by invoking a function of the Queue Processor 203, which gets the next inbound message. After processing is complete, the message is placed in the outbound queue 216 by invoking a function of the Queue Processor process 203, which places the message on the outbound queue 216. When an inbound message is retrieved, the Message Routing Engine 204 inspects the electronic envelope of the message, which is a collection of header information attached to the message and includes information on message incoming and outgoing formats, trading partner information, routing characteristics and application information for this transaction.

If necessary, the messages are sent to the Translation Engine 208 for processing. If the message does not require translating, then this process is skipped. The Translation Engine 208 receives messages from the Inbound Queue 215 off the Queue Processor 203. The Translation Engine 208 then transforms the message from the incoming message format to the Application Integration Network canonical format and then to the outbound message format. The Archiver process 207 processes and stores electronic messages passed to it for long-term storage. The Archiver 207 encapsulates an electronic message with a database ID and a timestamp to note when the electronic Message was archived. The Archiver 207 also prepares the given electronic message for archiving and inserts it into the Foundation Database 210. The Auditor process 206 creates an audit trail for each transaction that is processed by the Network Foundation 100. The Auditor process 206 logs Events. In the illustrative embodiment, an Event is a User Console Event logged as a result of a user event at the User Console 213. In other embodiments, other activities could be defined as Events for logging by the Auditor process 206. When logged by the Auditor process 206, Events encapsulate the time of the Event along with the activity (e.g., the type of User Console activity which occurred) and some reference information further defining the Event. In the illustrative embodiment, an auditable Event may result from a definable command that a user issues at the User Console 213. Trading Partner Profiles 205 are also managed within the service. Trading Partner Profiles 205 contain information about each specific trading partner connected to the Network Foundation 100. The information includes, but is not limited to location, division, contact information, applications used, data formats, communication protocols used, other trading partners within their network, etc.

All interactions with the Foundation Database 210 are funneled through the Database Access Manager 209 in the database software. The Database Access Manager 209 provides a level of abstraction through which each process-requiring interaction with the Foundation Database 210 achieves compatibility with the Foundation Database 210. The Database Access Manager 209 provides for every type of access and query required.

The Application Services processes 211, like the Database Access Manager 209, provide a layer of abstraction. The Application Services processes 211 present a common interface for the User Console 213, Admin/System Monitor 212 and Billing Information 214 to communicate with other parts of the Network Foundation (FIG. 1, 100). The Application Services processes 211 can include facilities for presenting a graphical interface. The Application Services processes 211 reside between user interface services such as the User Console 213 and Admin/System Monitor 212 and Billing Information 214, as well as future applications, and the internal services, such as the Translation engine 208, Archiver 207, Auditor 206, Trading Partner Profiles 205 and the Database Access Manager 209, available in the rest of the system. A programmer's application programming interface (API) is presented for external applications such as the User Console 213, etc. to communicate with the Application Services processes 211 interface directly with the Database Access Manager 209, the Translation Engine 208, Archiver 207, Auditor process 206, Trading Partner Profiles 205, etc., as needed. The User Console 213 provides the services necessary for a user to obtain direct access to the system. The Admin/System Monitor 212 allows system operators to administer and monitor the system. Customers 217, 218, 219 include, but are not limited to Trading Partners, Wireless Application Service Providers and Application Service Providers.

Within the Translation Engine 208 is a process called BabelFish, which provides two basic services: validation and translation. BabelFish operates on XML documents and is implemented using an XML parser. Any suitable parser compatible with a selected document format and language may be used. The validation process accepts a raw XML stream from the electronic payload that is the data portion of an electronic message. BabelFish then validates that the XML stream is well formed, and returns an XML Document object. This XML Document object can then be manipulated further.

Document translations are generally a two-step process: the first step is to translate from the incoming format to a canonical format and the second step translates from the canonical format to the necessary outgoing format. By using an intermediate, canonical format and a two-step translation process, fewer mappings are required because each format maps only to the canonical format, rather than to each other format.

The translation process to and from the canonical format employs XSLT template style sheets, as follows. BabelFish reads a given XML Document in accordance with a selected XSLT style sheet and produces the required translated document. If need be, this document can then be returned to the raw XML stream for further processing.

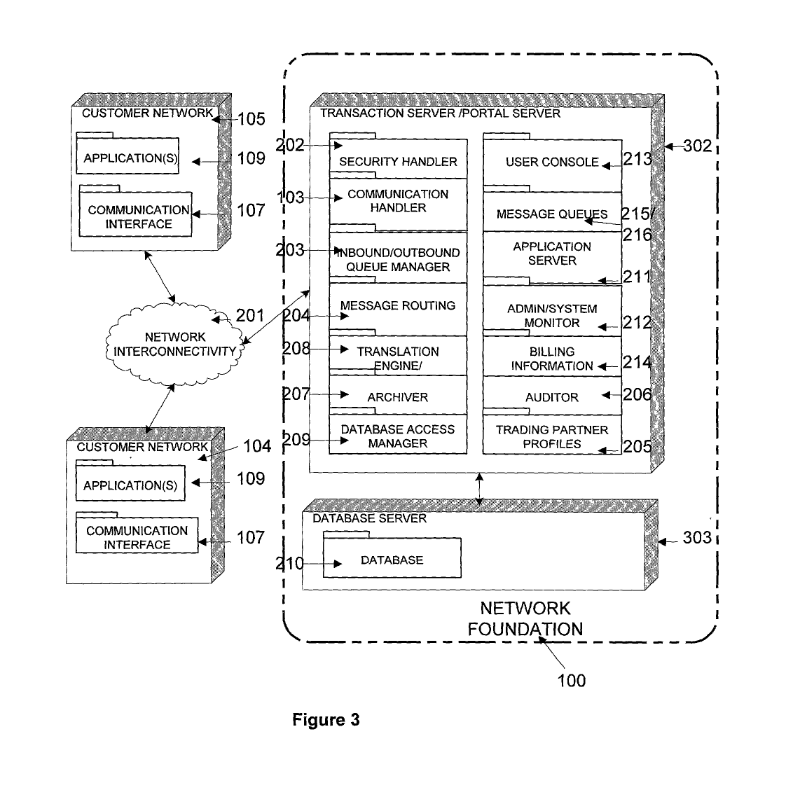

The physical layout of the network is now described in connection with FIG. 3. The client network (FIG. 1, 104, 105) will use a Communication Interface (FIG. 1, 107) that will communicate with the Security Handler (FIG. 2, 202) and Communication Handler (FIG. 1, 103) located on the Network Foundation (FIG. 1, 100) through the Network (FIG. 2, 201). At the customer site the Communication Interface (FIG. 1, 107) communicates with the Applications (FIG. 1, 109) on the Customer Network (FIG. 1, 103, 104). The Network (FIG. 2, 201) includes, but is not limited to various kinds of hardware and software including firewalls, telecommunication networks, and virtual private networks between the Customer Network (FIG. 1, 103, 104) and the Network Foundation 100. The Customer Network (FIG. 1, 103) can consist of servers, firewalls, etc., and does not affect the configuration of the Network Foundation (FIG. 1, 100). The Network Foundation 100 is configured to scale horizontally, that is to accommodate more Customer Networks (FIG. 1, 103, 104) and/or traffic, and can include one, two or more servers. The software processes loaded on the Transaction Server/Portal Server 302 and the Database Server 303 are built in a modular fashion and can scale up as required. The Network Foundation (FIG. 1, 100) has been designed to scale horizontally so that more Transaction Servers/Portal Servers 302 and Database Servers 303 can be added as user traffic and volume increases. The software processes loaded on the Transaction Server/Portal Server 302 and the Database Server 303 were described in connection with FIG. 2. The software processes executing on the Transaction Server/Portal Server 302 include the Security Handler (FIG. 2, 202), Communication Handler (FIG. 1, 103), Inbound/Outbound Queue Manager (FIG. 2, 203), the Message Queues (FIG. 2, 215, 216), Message Routing (FIG. 2, 204), Translation Engine (FIG. 2, 208), Archiver (FIG. 2, 207), Database Access Manager (FIG. 2, 209), Application Server (FIG. 2, 211), Admin/System Monitor (FIG. 2, 212), User Console (FIG. 2, 213), Billing Information (FIG. 2, 214), Auditor (FIG. 2, 206) and Trading Partner Profiles (FIG. 2, 205). The software processes loaded on the Transaction processor/Database Server 303 include the Foundation Database (FIG. 2, 210).

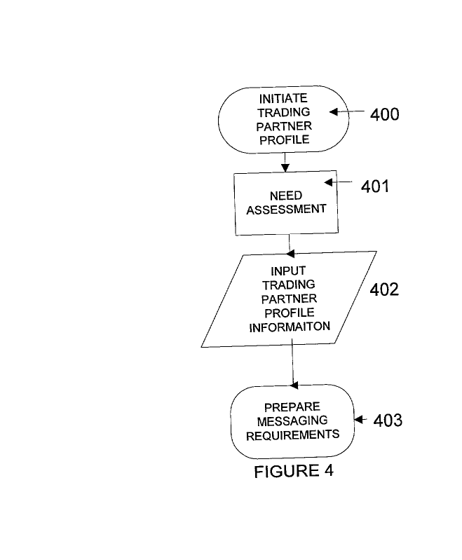

FIG. 4 shows the process of initiating a Trading Partner Profile 400. A customer with a message translation and delivery need will provide a consistent set of information outlining their integration requirements. An Application Integration Network operator or a third party systems integrator will perform a needs assessment 401 to determine the integration requirements for the processing of messages. The configuration information is used in determining the message processing requirements as well as message header information and should include: message formats, delivery methods, adapter configuration, availability requirements, security requirements, application utilized, location, contact information and notification information. The requirements are used as inputs 402 into the Trading Partner Profile system (FIG. 2, 205) in a standard format as defined by the apparatus. Message requirements are subsequently prepared 403 from the Trading Partner Profile (FIG. 2, 205).

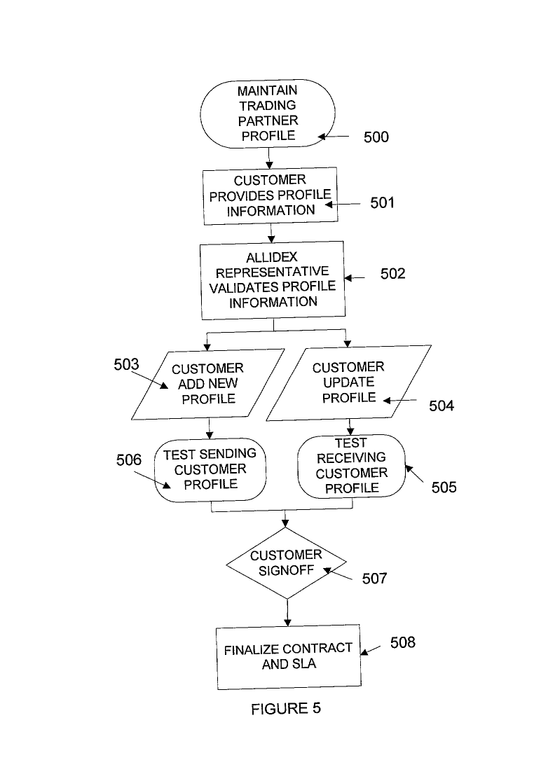

Next described in connection with FIG. 5, maintaining a Trading Partner Profile 500 contains the actions involved in maintaining a Trading Partner Profile (FIG. 2, 205) of customer information. Information in a Trading Partner Profile can include one or more of the following, or other information as may be desired: addresses and other information enabling communication with the customer's servers; customer's billing information; customer contact information and application translation information. First, the customer provides Trading Partner Profile information 501, including contact information, host server IP address, security levels and billing information to the Application Integration Network operator. This may be provided via email or via a form on the User Console (FIG. 2, 213).

The Application Integration Network operator validates 502, then, if the profile is a new Trading Partner Profile 503, enters the Trading Partner Profile 503 through the User Console (FIG. 2, 213). If the profile is an existing Trading Partner Profile 504, then the Application Integration Network operator enters 504 the updated Trading Partner Profile information into the Trading Partner Profile system (FIG. 2, 205). The operator may also document the changes in a notes section of the Trading Partner Profile. In order to ensure proper configuration information has been established, the Application Integration Network operator sends a test message to the Receiving Customer's application and waits for a valid response 505. The Sending Customer's application is then also sent a test message and a valid response awaited 506. After both test messages have been validated, the Trading Partner Profile is validated and the customer signs off 507. To finalize the change processes, the Sales Representative finalizes a Customer contract and a Customer Service Level Agreement 508, establishing service to the Trading Partner.

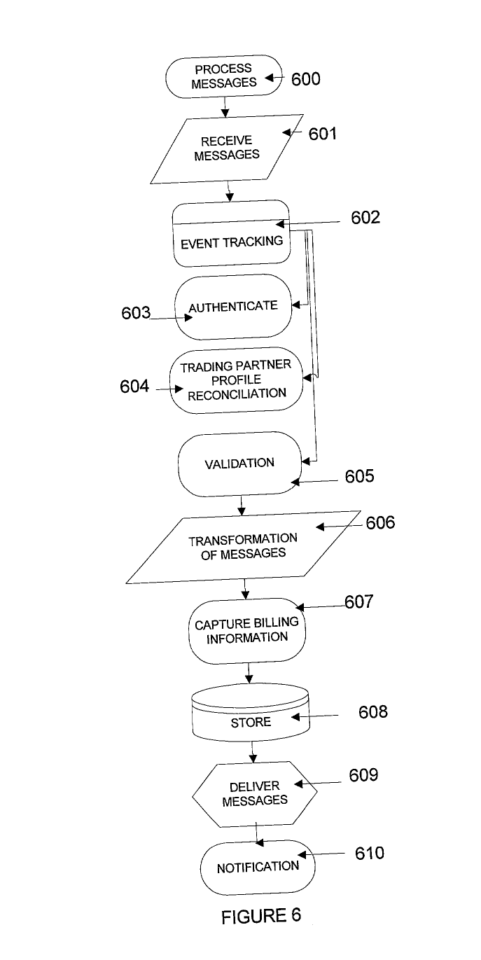

The next section details the processing of messages 600 as they are received by the Network Foundation as shown in FIG. 6. Client applications deliver messages to the Network Foundation for processing using their Communication Interfaces (FIG. 1, 107). Messages can be delivered in secure and un-secure modes using standard HTTP, HTTPS, FTP, JMS and SMTP protocols or any other understood by the Security Handler (FIG. 2, 202 and Communication Handler (FIG. 1, 103). The message format consists of standard formats including, but not limited to XML, ANSI x.12, Edifact and text. Messages are received 601 into the Inbound Queue (FIG. 2, 215), where the message header information is reviewed to determine the processes that will be performed on the data. Event Tracking 602 captures information on the services performed as data moves through the Application Integration Network. Tracking events includes, but is not limited to the processes defined below. Authentication 603 and validation 605 of messages can be performed using standard methods, such as digital certificates, secure socket layers (SSL) and Virtual Private Network Technologies. Messages are checked to ensure that they are sent by the authorized Trading Partner by reconciling 604 the message with a Trading Partner Profile. The Trading Partner Profile Reconciliation process 604 cross references message header information with the Trading Partner Profile records maintained in accordance with the method described above in connection with FIG. 5. Validating message formats 605 reduces the risk of generating bad data or processing a message incorrectly. Messages then are transformed from one message format to another 606 as dictated by the message details. Transformation will support multiple data formats including, but not limited to XML to XML, ASCII to XML and XML to ASCII, ANSIIX.12, Edifact and other formats as required. Rules regarding the transformation to be performed will be determined from the message origin, message format and destination of the message. Throughout the processing of the message, there is billing information captured 607 based on the value added services performed. The following information, including, but is not limited to the number of messages, the number and types of translations performed, multiple trading partner routings, document type, source message size, source message retention time, destination message size, source message retention, destination message retention, destination message retention time and portal usage is tracked and stored 608 by the system. Particular embodiments can omit one or more of the types of billing information tracked and stored or add other types of billing information tracked and stored. Messages can also be optionally stored 608. Storage requirements of particular Customers are defined in each Customer's Trading Partner Profile (FIG. 2, 205). After processing, messages will be securely delivered 609 to the trading partner site in the format provided in the Trading Partner Profiles (FIG. 2, 205). The messages can be delivered 609 to the trading partner for manual upload into their systems or they can be delivered directly into the applications depending on the trading partner's capabilities. The electronic information received by the Application Integration Network can also be directed through a service provider who could then transform the transactions to a fax format to be sent as a paper transaction to the trading partner. Message alerts or notifications 610 alerting trading partners of problems with message data, receipts for received and sent data and billing will also be processed for messages moving through the Network Foundation (FIG. 1, 100). Notifications are delivered to the customer via e-mail or through web site access.

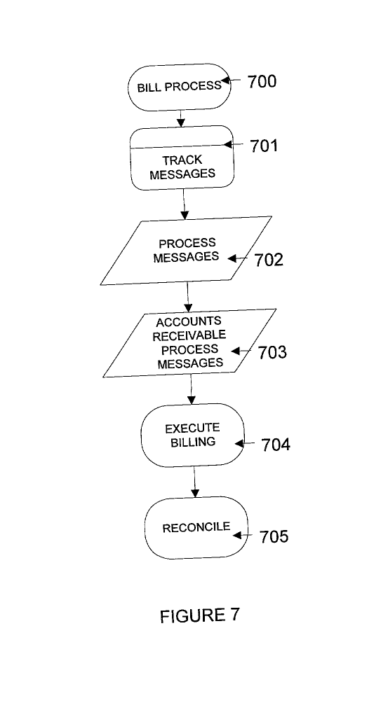

FIG. 7 is now described, further defining the Billing Process 700. Various user-initiated processes, such as message tracking, notifications and activity on the User Console (FIG. 2, 213) will generate billable events 701. Messages processed by the system, for example messages translated, routed, stored, etc., will also generate billable events 702. Billing event information generated in response to activities described above is communicated to an accounts receivable system for processing 703. The accounts receivable system need not be part of the Application Integration Network. A billing process 704 is then run. The reporting period for the billing process 704 is defined by a start date-time and an end date-time. The Application Integration Network can organize bills in a variety of ways. For example, if a group of trading partners are considered to be a trading community, one or more bills can be delivered to any one or more member of the trading community as required. One customer, for example, can pay an entire bill for a trading community. The Application Integration Network captures sufficient information to reconcile between the date a message was billed and the date the transaction is complete and the date revenue is recognized 705. It is also noted that a message can be billed before the entire transaction has completed processing through the Application Integration Network, e.g., before it has been delivered to destination trading partner(s).

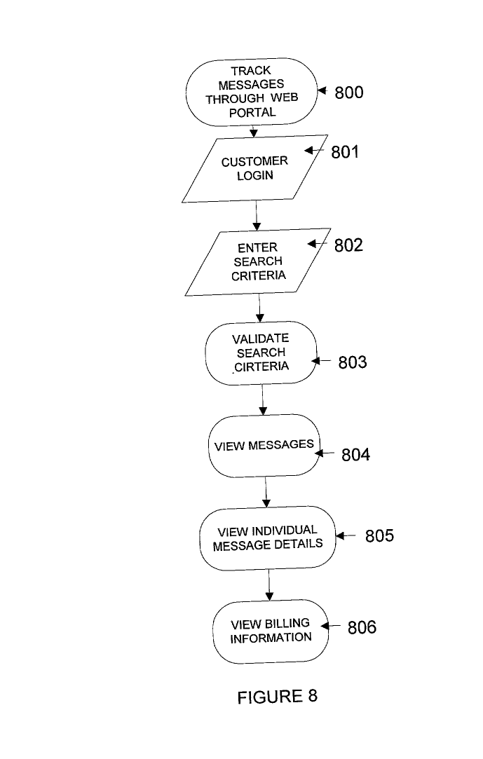

The process of tracking message activity 800 through the User Console (FIG. 2, 213) is now further described in connection with FIG. 8. This function allows a customer to view messages that have been sent or received by the Application Integration Network for the purpose of processing. The customer can obtain useful information about the status of messages for which they are authorized to obtain such information, as well as other information such as the time at which a message was sent to or received by the Network and the processing state of the message at any point in time. This function can be useful, for example, to find out if a message has been completely processed, or if processing of a message has failed, then where and why it failed.

The customer first logs onto the User Console (FIG. 2, 213) and the customer's identity validated 801. After login validation 801, the customer enters criteria used to filter which messages they will view 802. This criterion can include, but is not limited to the date on which messages where received by the Network, the origination trading partners of messages, the destination trading partners of messages, etc. Criteria entered by the customer are checked for the validity of the criteria entered and that the criteria are applicable to the message tracking system 803. In response, information is displayed that gives detailed summary information regarding messages that satisfy the customer's search criteria 804. When the customer subsequently selects a message, the complete message is displayed. A complete message is the unprocessed, unadulterated message that was sent 805. If one of the search criteria is origination, messages having a common trading partner as sender are selected. Information that has been generated for each customer action that has been defined as a billable event can also be viewed by the customer 806.

The operation of the illustrative embodiment is now described in greater detail.

Messages sent by a client trading partner may be generated by one of a plurality of business enterprise software packages. Typically, the message is then translated into a markup language such as XML, although other markup languages or data formats can be used. The message is then sent through the Communication Interface (FIG. 1, 107) and Network Interconnectivity (FIG. 2, 201) to the Network Foundation 100.

The Network Foundation (FIG. 1, 100) receives the message from the Communication Interface (FIG. 1, 107) via Security Handler 202 and the Communication Handler (FIG. 1, 103) into the Inbound and Outbound Queues (FIG. 2, 215, 216). The Message Routing Script Engine (FIG. 2, 204) picks up, authenticates and properly routes incoming messages and outgoing messages. Incoming messages then access the Trading Partner Profile Information (FIG. 2, 205) for translation and routing instructions. The Translation Engine (FIG. 2, 208) performs the necessary data transformation and submits information to the Archiver (FIG. 2, 207), and Auditor (FIG. 2, 206). The message information is tracked and then fed through the Applications Services (FIG. 2, 211) layer to the Billing Information (FIG. 2, 214) system and can be accessed by the User Console (FIG. 2, 213) or the Admin/System Monitor (FIG. 2, 212).

The inbound and outbound queues ((FIG. 2, 215, 216) are implemented in a conventional manner as electronic mailboxes. A typical message coming into the inbound query (FIG. 2, 215) or going out of the outbound query (FIG. 2, 216) is an electronic message containing header information including, but not limited to, sender and receiver information as well as a message payload. The electronic message is passed to the Message Routing Engine (FIG. 2, 204) by a channel handler. The Message Routing Engine (FIG. 2, 204) also requests the Archiver and Auditor (FIG. 2, 207, 206) to store the electronic message in the Foundation Database (FIG. 2, 210) in the electronic format. The message processes are recorded and the Billing Information System (FIG. 2, 214) create a billing record for the transaction. The Translation Engine (FIG. 2, 208) parses and translates the payload, e.g., the XML stream, of the electronic message. All activities by the Translation Engine, (FIG. 2, 208, the Message Routing Engine (FIG. 2, 204) Billing Information system (FIG. 2, 214) and the Archiver (FIG. 2, 207) are saved by the Auditor (FIG. 2, 206).

The Billing Information system (FIG. 2, 214) records billable events to the Foundation Database (FIG. 2, 210) for periodic reporting. Billing records stored in the Foundation Database (FIG. 2, 210) are accessed by the User Console (FIG. 2, 213). The archive stored in the Foundation Database (FIG. 2, 210) by the Archiver (FIG. 2, 207) can be used to improve service, provide decision support to customers, an audit trail for additional security and as a source of transaction-based billing. Electronic messages are restored from the archive in the same format as they are received into the archive. The User Console (FIG. 2, 213) provides client, trading partners via a web server, an interface to edit, execute or update information in their Trading Partner Profiles (FIG. 2, 205). The User Console (FIG. 2, 213) also reports on data stored in the Foundation Database (FIG. 2, 210), including messages, customer data, billing, as well as processing events.

The Auditor (FIG. 2, 206) writes performance, error and tracing messages to the Foundation Database (FIG. 2, 210). If access to the Foundation Database (FIG. 2, 210) is blocked, for example, when storage space runs low, the Auditor (FIG. 2, 206) can write logs to an alternate file system.

The User Console (FIG. 2, 213) provides controlled access to the client trading partner's data in the system. The User Console (FIG. 2, 213) is designed to work with standard user interfaces, for example web browsers. Clients trading partners can also track and reconcile records concerning messages sent to and from their system via the AIN™ Foundation (FIG. 1, 100) through access provided to the client trading partners via the User Console (FIG. 2, 213). The User Console (FIG. 2, 213) restricts the accessibility of client trading partner's data using conventional authentication and logic methods. Valid authentication will grant in turn access to interface screens, which access data. In addition, authentication can also restrict access to specific data associated with the specific user member of the client trading partner organization. Finally, user authentication can restrict access to the user's partition of the physical data repository. Users can be assigned roles with associated responsibility that will permit varying levels access to data. Only operations that view data are permitted from the User Console (FIG. 2, 213) updating the database is prohibited from the User Console (FIG. 2, 213) although script editing may be permitted to appropriate users.

The User Console interface can be designed to support web browsers such as Internet Explorer, Netscape, and others that provide client side Java support. Communication infrastructure is also required between the user's browser and the User Console process (FIG. 2, 213), such as an Internet connection (FIG. 2, 201).

Further modifications and equivalents of the invention herein disclosed will occur to persons skilled in the art using no more than routine experimentation and all such modifications and equivalents are believed to be within the spirit and scope of the invention as defined by properly construing the following claims.

What is claimed is:

1. A method of facilitating communication of electronic data between a plurality of trading partners through a managed third party network, comprising:
receiving an input message into the managed third party network, the input message conforming to an input schema from a first trading partner;
storing the message;
transforming the message into an intermediate format message conforming to a canonical schema;
storing the transformed message;
transforming the intermediate format message into an output message conforming to an output schema; and
sending the output message over the network to a second trading partner adapted to receive messages conforming to the output schema.

2. The method of claim 1, further comprising:
tracking the events and services performed by the managed third party network.

3. The method of claim 2, further comprising:
billing for the events tracked.

4. The method of claim 3, further comprising:
connecting with one of the plurality of trading partners to bill for the events tracked.

5. The method of claim 1, further comprising:
transforming the output message content into an intermediate content conforming to a canonical content format;
storing the transformed message content; and
transforming the intermediate content into the output message understood by the second trading partner.

6. The method of claim 5, further comprising:
identifying the input message to at least one of the trading partners.

7. The method of claim 6, further comprising:
billing for activities and events of the managed third party network, bills being directed to the one of the trading partners identified with the input message.

8. The method of claim 6, further comprising:
identifying the output message to at least one of the trading partners.

9. The method of claim 8, further comprising:
billing for activities and events of the managed third party network, bills being directed to the one of the trading partners identified with the output message.

10. The method of claim 1, wherein the input schema and the output schema are different.

11. The method of claim 1, further comprising:
auditing and processing messages to identify software usage and tracking information pertaining to a trading partner.

12. The method of claim 1, wherein sending the output message to a second trading partner adapted to receive messages conforming to the output schema further comprises:
sending the output message to an apparatus for internal application integration used by the second trading partner.

13. The system of claim 1, further comprising:
means for providing secure authenticated and validated transactions.

14. The system of claim 1, further comprising:
means for facilitating communication between at least three trading partners at the same time connected to the network.

15. A system through which a service managed by a third party facilitates communication between a plurality of trading partners, wherein a per-trading partner cost associated with receiving, authenticating, validating, translating and delivery of incoming messages and outgoing messages is reduced, the system comprising:
a first processor executing software to receive, queue and transmit an incoming message having message content in an incoming message format and an outgoing message in an outgoing message format;
a first processor executing software to transform a message queued by the first processor into an intermediate message format conforming to a canonical schema, and to transform the message content into an outgoing message content representation according to a predetermined trading agreement; and
software executing on the first processor to link processes executed on that second processor to a trading partner's system.

16. The system of claim 15, further comprising:
software executing on the first processor to transform a message in the intermediate message format into the outgoing message format.

17. The system of claim 15, further comprising:
software executing on the second processor to store information related to activities, events and processes performed within the system.

18. The system of claim 15, the second processor executing software to store XSLT libraries developed for mapping data as defined in a message header and the predetermined trading agreement.

19. The system of claim 18, the first processor further comprising:
a communication handler that acts as a transport mechanism for multiple protocols to receive the incoming messages.

20. The system of claim 19, the software executing on the first processor further comprising:
a message queuing engine which stores the incoming messages on an incoming queue.

21. The system of claim 20, the software executing on the first processor further comprising:
a message routing/scripting engine which retrieves from the incoming queue, a message for transformation.

22. The system of claim 21, further comprising:
a database system that stores and retrieves queued and transformed messages.

23. The system of claim 22, further comprising:
a trading partner and system administrator user interface through which are obtained reports on queued and transformed messages.

24. The system of claim 23, wherein the user interface is based on access to hypertext documents through a browser client.

25. The system of claim 24, wherein the user interface is accessed through a world-wide computer network.

26. The system of claim 25, wherein the user interface provides access to a System Administrator for system monitoring and support activities.

27. The system of claim 15, further comprising:
a database system that stores and retrieves the canonical schema.

28. The system of claim 15, wherein messages are represented in a markup language.

29. The system of claim 28, wherein the markup language is an XML language.

30. The system of claim 29, wherein the software to transform includes scripts written in XSLT.

31. The system of claim 15, wherein messages are represented in a ANSI X.12 or Edifact language.

32. The system of claim 15, wherein messages are represented in a text or comma separated value language.

33. The system of claim 15, wherein the system processes messages between the plurality of trading partners and compiles billing information and records based on the messages processed.

34. The system of claim 15, wherein the system receives messages for processing containing specific information about software usage by a trading partner from apparatuses located at the trading partner.

35. The system of claim 15, further comprising an audit process which compiles and analyzes software usage information and message content information, whereby the third party subsequently charges a trading partner for services rendered.

36. The system of claim 15, wherein the message content includes audio files.

37. The system of claim 15, wherein the message content includes video files.

38. The method of claim 11 further comprising:
sending software usage information to trading partners or software vendors.
